(19) United States
(12) Patent Application Publication
(10) Pub. No.: US 2024/0300574 A1
(43) Pub. Date: Sep. 12, 2024

(54) HANDWHEEL ACTUATOR FOR STEERING SYSTEM

(71) Applicant: Schaeffler Technologies AG & Co. KG, Herzogenaurach (DE)

(72) Inventor: Todd Sturgin, Wooster, OH (US)

(73) Assignee: Schaeffler Technologies AG & Co. KG, Herzogenaurach (DE)

(21) Appl. No.: 18/426,418

(22) Filed: Jan. 30, 2024

Related U.S. Application Data
(60) Provisional application No. 63/451,301, filed on Mar. 10, 2023.

(51) Int. Cl. B62D 5/09; B62D 5/12

(52) U.S. Cl. CPC B62D 5/091; B62D 5/12

(57) ABSTRACT

A handwheel actuator for a steering system includes a housing, a piston slidably disposed within the housing, and a shaft disposed within the housing and configured to be fixed to a handwheel. A first side of the piston forms a first fluid chamber with the housing, and a second side of the piston forms a second fluid chamber with the housing. The first and second chambers are configured to be fluidly connected to each other. The shaft and piston cooperate to convert an input rotary motion of the shaft to an output linear motion of the piston. The linear motion of the piston is configured to displace a fluid so as to apply a rotational resistance to the shaft.

### CROSS-REFERENCE TO RELATED APPLICATIONS

This application claims priority to U.S. Provisional Application No. 63/451,301 filed Mar. 10, 2023, the entire disclosure of which is incorporated by reference herein.

### TECHNICAL FIELD

This disclosure is generally related to a handwheel actuator for a drive-by-wire steering system.

### BACKGROUND

In a drive-by-wire or steer-by-wire system, a steering wheel has no natural force feedback for a driver, and so without an additional mechanism or software, the driver input may feel unnatural depending on the driving condition compared to a conventional mechanical steering system.

### SUMMARY

An example embodiment of a handwheel actuator for a steering system is provided that includes a housing and a piston slidably disposed within the housing. The piston includes a first end that forms a first fluid chamber with the housing and a second end that forms a second fluid chamber with the housing. The second fluid chamber is configured to be fluidly connected to the first fluid chamber. The handwheel actuator also includes a shaft that is disposed within the housing. The shaft and piston cooperate to convert rotary motion of the shaft to linear motion of the piston within the housing. The linear motion of the piston displaces a fluid which, in turn, provides a rotational resistance to the shaft.

In an example embodiment, the shaft and piston define a threaded interface that converts the rotary motion of the shaft to the linear motion of the piston.

In an example embodiment, rotation of the shaft in a first rotational direction causes the piston to move in a first axial direction, and rotation of the shaft in a second rotational direction causes the piston to move in a second axial direction. In a further aspect, movement of the piston in the first axial direction reduces a volume of the first fluid chamber and increases the volume of the second fluid chamber; and movement of the piston in the second axial direction increases the volume of the first fluid chamber and decreases the volume of the second fluid chamber.

In an example embodiment, linear motion of the piston is configured to push the fluid out of one of the first fluid chamber or the second fluid chamber and into a remaining one of the first fluid chamber or the second fluid chamber so as to produce a rotational resistance.

In an example embodiment, the piston has a metered fluid passage that fluidly connects the first fluid chamber to the second fluid chamber. In a further aspect, the metered fluid passage is electronically metered via an electronic control valve.

In an example embodiment, the handwheel actuator has a fluid flow path that fluidly connects the first fluid chamber to the second fluid chamber, and the rotational resistance is provided via selectively varying a flow area of the fluid flow path.

In an example embodiment, a first spring is arranged within the first fluid chamber and a second spring is arranged in the second fluid chamber. In one further aspect, the first spring is configured to apply a first axial force to a first axial end of the piston, and the second spring is configured to apply a second axial force to a second axial end of the piston. In another further aspect, the first spring and the second spring are configured to move the piston to a linear position that corresponds with a non-turning position of the handwheel in which the wheels of a vehicle are in a straight or non-turning position.

In an example embodiment, the shaft extends through the piston and is rotatably supported by the housing.

An example embodiment of a handwheel actuator for a steering system includes a housing and a shaft configured to receive an input torque from a handwheel. The housing has a rotational axis (via the shaft), a wall movable in an axial direction, a first volume expandable and compressible via the wall, and a second volume expandable and compressible via the wall. The second volume is sealingly separated from the first volume via the wall. The shaft is configured to further receive a resistant torque via the first volume and the second volume, and a return torque via the first volume and the second volume. The return torque is configured to rotate the shaft to achieve a non-turning position of the handwheel.

In an example embodiment, the resistant torque is provided via compressed fluid within one of the first volume or the second volume.

In an example embodiment, the return torque is provided via a first axial force applied within the first volume or a second axial force applied within the second volume.

In an example embodiment, the shaft extends through both the first volume and the second volume.

In an example embodiment, the shaft extends outside of the housing.

In an example embodiment, the wall and the shaft define a threaded interface configured to convert rotary movement of the shaft to linear movement of the wall.

In an example embodiment, when the shaft rotates in a first direction, the first volume decreases in size and the second volume increases in size; and when the shaft rotates in the second direction, the first volume increases in size and the second volume decreases in size.

### BRIEF DESCRIPTION OF THE DRAWINGS

The foregoing Summary will be best understood when read in conjunction with the appended drawings. In the drawings:

FIG. 1 shows an exploded perspective view of an example embodiment of a handwheel actuator together with a handwheel.

FIG. 2 shows a cross-sectional perspective view of the handwheel actuator of FIG. 1.

FIG. 3 shows a perspective view of a nut of the handwheel actuator of FIG. 1.

FIG. 4 shows a perspective view of a shaft of the handwheel actuator of FIG. 1.

FIG. 5 shows a perspective view of a piston of the handwheel actuator of FIG. 1.

FIG. 6 shows a cross-sectional view of an example embodiment of an electronic control valve.

FIG. 7 shows a schematic representation of a drive-by-wire steering system of a vehicle.

FIG. 8 shows a cross-sectional perspective view of a portion of an example embodiment of a handwheel actuator and handwheel assembly.

FIG. 9 shows a cross-sectional perspective view of the handwheel actuator of FIG. 8.

### DETAILED DESCRIPTION

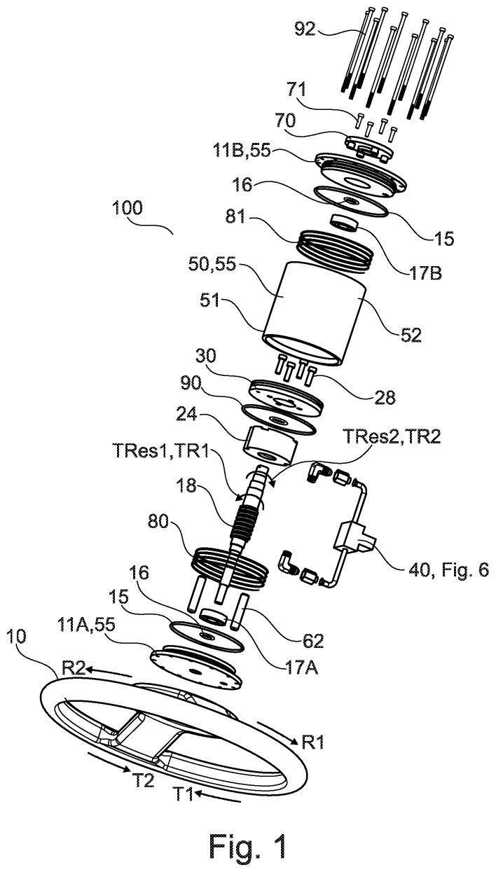

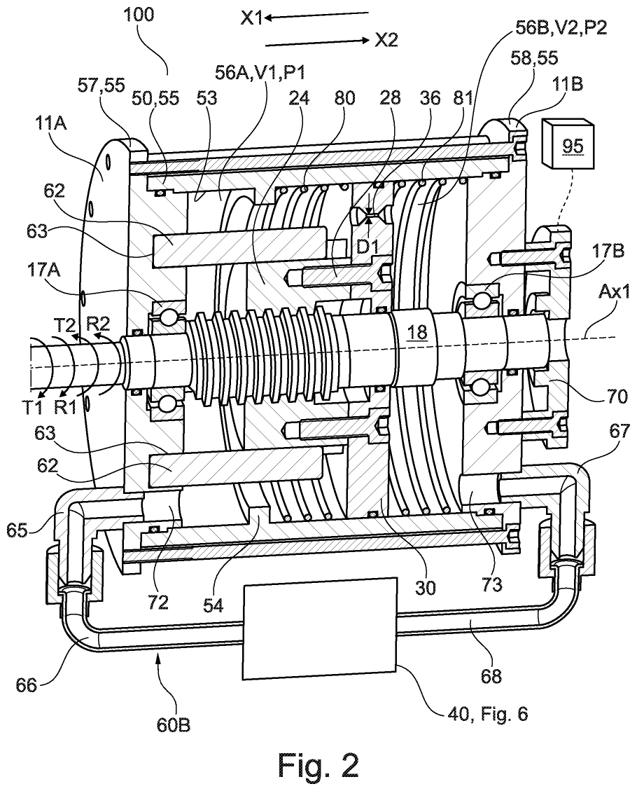

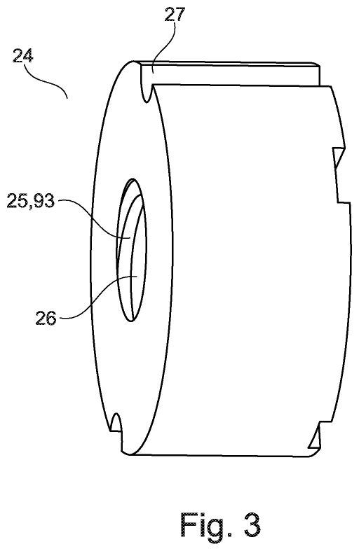

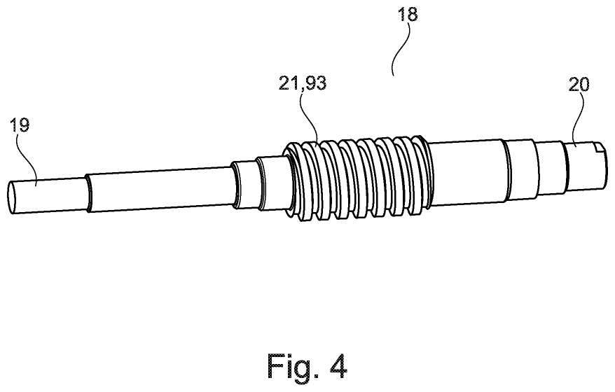

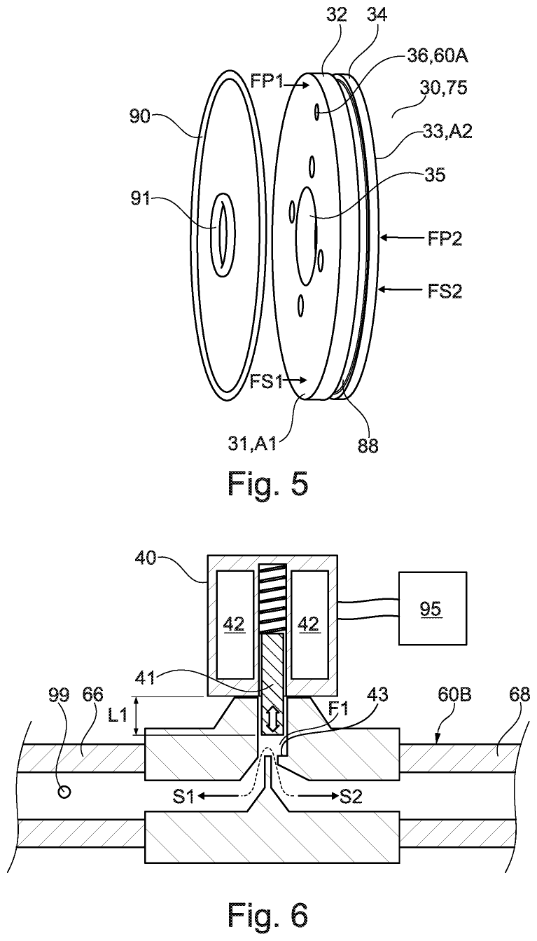

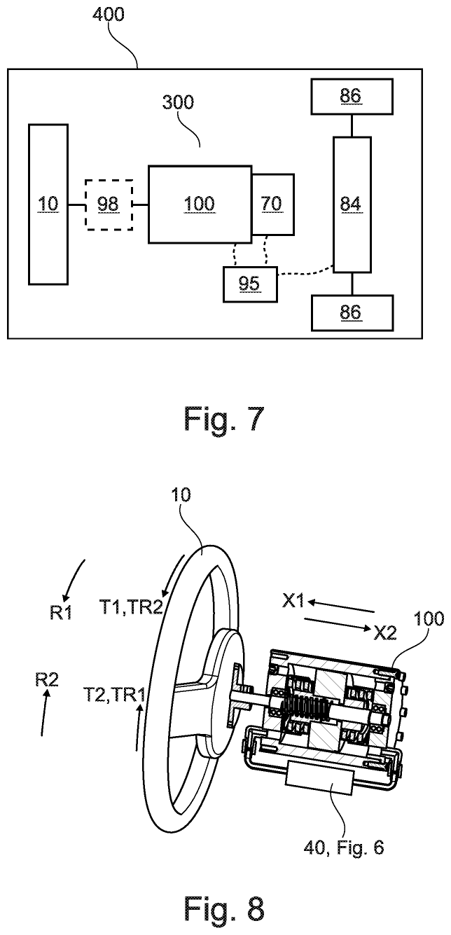

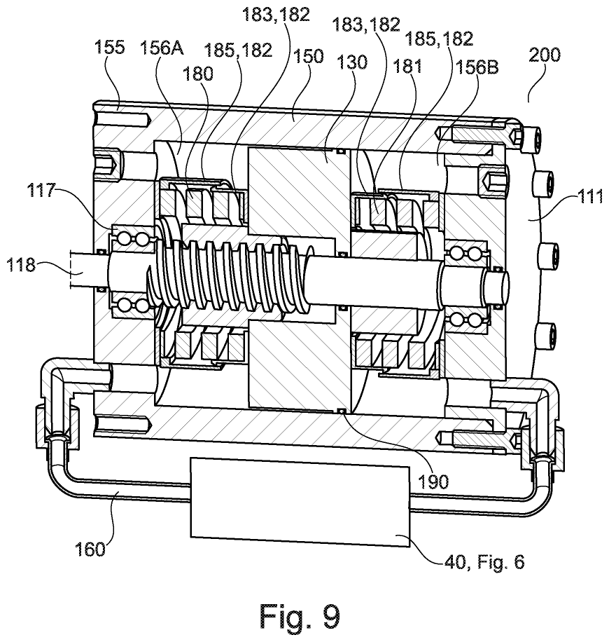

FIG. 1 shows an exploded perspective view of an example embodiment of a handwheel actuator 100 together with a handwheel 10. FIG. 2 shows a cross-sectional perspective view of the handwheel actuator 100. FIG. 3 shows a perspective view of an example embodiment of a nut 24 for the handwheel actuator 100. FIG. 4 shows a perspective view of an example embodiment of a shaft 18 for the handwheel actuator 100. FIG. 5 shows a perspective view of an example embodiment of a piston 30 together with a corresponding circumferential piston seal 90 and a medial shaft seal 91 for the handwheel actuator 100. FIG. 6 shows a cross-sectional view of an example embodiment of an electronic control valve 40 of the handwheel actuator 100. FIG. 7 shows a schematic diagram of a vehicle 400 that includes a drive-by-wire steering system 300. The following should be read in light of FIGS. 1-7.

The drive-by-wire steering system 300 schematically represented in FIG. 7 shows the handwheel 10, an optional gearbox 98, the handwheel actuator 100, a handwheel sensor 70, an electronic control unit (ECU) 95, a steering actuator 84, and wheels 86. The ECU 95 communicates electronically with the handwheel actuator 100, the handwheel sensor 70, and the steering actuator 84. That is, the ECU 95 is configured to either receive an electronic signal or provide an electronic signal to any of these components. Furthermore, the ECU 95, as known within vehicle applications, can control the drive-by-wire steering system 300 so that an operator or driver input to the handwheel 10 is translated to a steering action of the wheels 86 via the electronically controlled steering actuator 84. Given that there is no mechanical connection between the handwheel 10 and the wheels 86, the handwheel actuator 100 is configured to provide force feedback to the driver or operator during a steering process of the vehicle 400. The optional gearbox 98 drawn with a broken line in FIG. 7, can operatively connect the handwheel 10 to the handwheel actuator 100 and provides a means of adjusting a torque and/or a speed input to the handwheel actuator 100 from the handwheel 10, as necessary. With or without the gearbox 98: i) the handwheel actuator 100 is driven or rotated (or drivably rotated) via the handwheel 10; and ii) the handwheel actuator 100 receives an input torque via the handwheel 10.

The handwheel 10, sometimes referred to as a steering wheel, can also be fixed to the shaft 18 of the handwheel actuator 100 so that the handwheel 10 and shaft 18 rotate in unison together about a rotational axis AX1. The shaft 18 is supported by a first rolling element bearing 17A and a second rolling element bearing 17B. The first and second rolling element bearings 17A, 17B can be ball bearings, angular contact ball bearings, or any other suitable type of bearing. The first rolling element bearing 17A is housed within a first disc-shaped end cap 11A, and the second rolling element bearing 17B is housed within a second disc-shaped end cap 11B. The first and second end caps 11A, 11B are sealingly attached or fixed to respective first and second open ends 51, 52 of a tubular enclosure 50 via enclosure bolts 92 and circumferential seals 15. The enclosure bolts 92 extend throughout a longitudinal length of the enclosure 50. The first and second end caps 11A, 11B could also be fixed to the enclosure 50 via welding, crimping, or any other suitable attachment method. The circumferential seals can be o-rings or any other suitable seal, and directly seal a radial outer surface of the first and second end caps 11A, 11B against a radial surface of a bore 53 of the enclosure 50. The enclosure 50 and the first and second end caps 11A, 11B provide a sealed environment for internal components of the handwheel actuator 100. The enclosure 50 and the first and second end caps 11A, 11B form a housing 55 of the handwheel actuator 100.

The shaft 18 is sealably received by the housing 55 via shaft seals 16 located axially outward of the first and second rolling element bearings 17A, 17B. A first end 19 of the shaft 18 protrudes from a first end 57 of the housing 55 and attaches to the handwheel 10. A second end 20 of the shaft 18 protrudes from a second end 58 of the housing 55 and interfaces with a sensor 70. The shaft 18 and the nut 24 define a threaded interface 93 that can convert rotary motion to axial (or linear) motion and axial motion to rotary motion. The shaft 18 is threadably engaged with the nut 24 via longitudinally extending external threads 21 of the shaft 18 that engage with internal threads 25 formed on a through-bore 26 of the nut 24. The external threads 21 and the internal threads 25 can be either right-handed threads or left-handed threads. Therefore, depending on the handedness of the external threads 21 and the internal threads 25, rotation of the shaft 18 in a first rotational direction R1 could yield either linear motion of the nut in a first axial direction X1 or a second axial direction X2. The threaded interface 93 can implement balls, if necessary, as a means of reducing friction. Furthermore, the threaded interface 93 can incorporate a lead screw arrangement, a planetary roller screw arrangement or any other suitable threaded arrangement.

The nut 24 is fixed to the piston 30 via fasteners 28; therefore, the nut 24 and piston 30 move in unison together. Other suitable ways to attach the nut 24 to the piston 30 are also possible. The shaft 18 extends through the through-bore 26 of the nut 24 and sealingly through a through-aperture 35 of the piston 30 via a piston shaft seal 91.

When the handwheel 10 is rotated either in a first direction R1 (clockwise) or a second direction R2 (counterclockwise), corresponding rotation of the shaft 18 occurs which causes axial movement of the piston 30 via the threaded interface 93. Thus, rotational motion of the handwheel 10 and shaft 18 is converted to linear motion of the piston 30. To prevent rotation of the nut 24 and piston 30 assembly during rotation of the shaft 18, anti-rotation pins 62 extend from blind bores 63 of the first end cap 11A and engage anti-rotation grooves 27 of the nut 24. Other suitable ways to prevent rotation of the nut 24 and piston 30 assembly are also possible.

The piston 30 can take the form of a disc or a cylinder and includes a circumferential groove 88 that contains the piston seal 90 so that the piston 30 can slidably and sealingly engage the radial surface of the bore 53 of the housing 55. In an example embodiment, the piston seal 90 is not required and an inherent sealing is accomplished via controlled sizes (and tolerances thereof) of the outer diameter of the piston 30 and an inner diameter of the bore 53. A first axial surface 31 located at a first axial end 32 of the piston 30 forms a first fluid chamber 56A with the housing 55. A second axial surface 33 located at a second axial end 34 of the piston 30 forms a second fluid chamber 56B with the housing 55. The piston 30 and first and second fluid chambers 56A, 56B are contained or disposed within the bore 53 of the housing 55. The first and second axial surfaces 31, 33 of the piston 30 engage directly with the fluid contained within the respective first and second fluid chambers 56A, 56B. The first fluid chamber 56A is fluidly connected to the second fluid chamber 56B via one or both of: i) a first metered fluid passage 60A defined by an orifice 36 that extends axially through the piston 30, and ii) a second metered fluid passage 60B managed by an electronic control valve 40. The first and second fluid chambers 56A, 56B are filled with any fluid 99 that is suitable for the handwheel actuator 100. The first fluid chamber 56A could also be described as a first volume V1 and the second fluid chamber 56B could also be described as a second volume V2.

In an example embodiment, the piston 30 does not include the first metered fluid passage 60A and the piston 30 sealingly separates first fluid chamber 56A from the second fluid chamber 56B within the housing 55. Stated otherwise, the first and second fluid chambers 56A, 56B are sealingly isolated from one another via the piston 30.

In an example embodiment, when the handwheel 10 is rotated in the first rotational direction R1 by an operator or occupant of a vehicle, the piston 30 is actuated in the first axial direction X1 so that the first fluid chamber 56A (or first volume V1) is compressed and the second fluid chamber 56B (or second volume V2) is expanded. When this occurs, compression of the first fluid chamber 56A increases a fluid pressure P1 within the first fluid chamber 56A, and expansion of the second fluid chamber 56B decreases a fluid pressure P2 within the second fluid chamber 56B. The resultant pressure differential (P1-P2) between the two chambers can cause the fluid to flow from the first fluid chamber 56A to the second fluid chamber 56B via one or both of the first metered fluid passage 60A defined by the orifice 36 and the second metered fluid passage 60B managed by the electronic control valve 40.

The exchange of the fluid 99 from first fluid chamber 56A (or first volume V1) to the second fluid chamber 56B (or second volume V2) can also occur due to the fluid being pushed out of the first fluid chamber 56A and into the second fluid chamber 56B via the piston 30 and one or both of the first and second metered fluid passages 60A, 60B. In an example embodiment, a total volume of the fluid contained within the first and second fluid chambers 56A, 56B and the first and second metered fluid passages 60A, 60B is held constant throughout various linear positions of the piston 30. Therefore, when the piston 30 is linearly displaced within the housing 55, a volume of the fluid that is removed from the corresponding reduced-volume fluid chamber is equal to a volume of the fluid that is added to the corresponding increased-volume fluid chamber, assuming that a fluid pathway of at least one of the first and second metered fluid passages 60A, 60B is open and the first and second fluid chambers 56A, 56B and the first and second metered fluid passages 60A, 60B are full of fluid.

The orifice 36 extends through the piston 30 from a first axial surface 31 to a second axial surface 33, defining a continuous fluid connection between the first fluid chamber 56A and the second fluid chamber 56B. A diameter D1 of the orifice 36 can be adjusted to tune the resistance provided by either of the first and second fluid chambers 56A, 56B during linear displacement of the piston 30. The electronic control valve 40 can be that of a solenoid valve which is electronically controlled by an electronic control unit (ECU) 95 and is configured to vary a fluid flow (or flow resistance or flow restriction) through the second metered fluid passage 60B to control a rotational resistance of the handwheel 10. The electronic control valve 40 selectively fluidly connects the first fluid chamber 56A to the second fluid chamber 56B.

Turning to FIG. 2, the second metered fluid passage 60B extends outside of the housing 55 and includes a first fluid fitting 65 attached to a first through-aperture 72 of the first end cap 11A, a second fluid fitting 67 attached to a second through-aperture 73 of the second end cap 11B, a first pipe 66 that fluidly connects the first fluid fitting 65 to the electronic control valve 40, and a second pipe 68 that fluidly connects the second fluid fitting 67 to the electronic control valve 40. The first fluid fitting 65 is fluidly connected to the first fluid chamber 56A via the first through-aperture 72, and the second fluid fitting 67 is fluidly connected to the second fluid chamber 56B via the second through-aperture 73. Fluid 99 can flow from the first fluid chamber 56A to the second fluid chamber 56B by flowing through, in succession, the first end cap 11A, the first fluid fitting 65, the first pipe 66, the electronic control valve 40, the second pipe 68, the second fluid fitting 67, and the second end cap 11B. Fluid 99 can flow from the second fluid chamber 56B to the first fluid chamber 56A by flowing through, in succession, the second end cap 11B, the second fluid fitting 67, the second pipe 68, the electronic control valve 40, the first pipe 66, the first fluid fitting 65, and the first end cap 11A. When the fluid 99 flows from the first chamber 56A to the second fluid chamber 56B, it flows through the electronic control valve 40 in the second direction S2; and when the fluid 99 flows from the second fluid chamber 56B to the first fluid chamber 56A, it flows through the electronic control valve 40 in the first direction S1.

Turning to FIG. 6, the electronic control valve 40 includes a pin 41 that is actuated up and down (relative to FIG. 6) via a coil 42. In an upward position of the pin (as shown), fluid flow can occur between the first and second fluid chambers 56A, 56B. When the pin 41 moves downward to engage a seat 43, flow is prevented from flowing between the first and second fluid chambers 56A, 56B. The electronic control valve 40 can be that of any suitable type to vary a flow area (or cross-sectional flow area) of the second metered fluid passage 60B, including, but not limited to an on/off style valve or a proportional valve, both known in the field of electronic control valves. The electronic control valve 40 could be configured to receive a pulse-width-modulated (PWM) digital signal, known in the field of electronic control valves, from the ECU 95. A frequency and duration of disengagement and engagement of the seat 43 by the pin 41 via the PWM signal, or stated otherwise, a frequency and duration of successive opening and closing of the electronic control valve 40 can be varied to control a fluid flow resistance of the second metered fluid passage 60B. This variation is accomplished by energization or de-energization of the coil as controlled by the ECU 95.

If the electronic control valve 40 is a proportional valve, a protrusion length L1 of the pin 41 can be controlled so that its proximity to the seat 43 can be varied. The electronic control valve 40 could be described as that which creates a selective flow resistance by selectively varying a flow area F1 of the second metered fluid passage 60B. In an example embodiment, when the pin 41 is engaged with the seat 43, the flow area F1 is zero; and when the pin 41 is not engaged with the seat 43, the flow area F1 is greater than zero. In a further example embodiment with the application of a proportional valve, the flow area F1 can variably increase from zero to a pre-determined amount defined by the protrusion length L1 of the pin 41. A decreasing protrusion length L1 yields a decreasing fluid flow resistance, and an increasing protrusion length L1 yields an increasing flow resistance. Alternatively described, the second metered fluid passage 60B could be described as a “flow path” that extends between the first and second fluid chambers 60A, 60B, and the electronical control valve 40 selectively controls: i) a size of the flow path (or size of an opening thereof), or ii) a magnitude of obstructing or blocking of the flow path via the pin 41.

Regardless of the valve type or control method, the electronic control valve 40 selectively varies the fluid flow resistance of the second metered fluid passage 60B. The harder it is to push fluid through the electronic control valve 40, the higher the fluid flow resistance. As fluid flow resistance increases, the resistant torque provided by the first or second fluid chambers 56A, 56B increases; and as the fluid flow resistance decreases, the resistant torque provided by first or second fluid chambers 56A, 56B decreases. The electronic control valve 40 can be constructed differently than that which is depicted within the figures.

In an example embodiment, the handwheel actuator 100 only includes the first metered fluid passage 60A. In a further example embodiment, the handwheel actuator 100 only includes the second metered fluid passage 60B. In yet a further example embodiment, the handwheel actuator includes both the first metered fluid passage 60A and the second metered fluid passage 60B.

In an example embodiment, the handwheel 10 only includes the second metered fluid passage 60B and can be locked in a rotational position via a closed position of the electronic control valve 40 so that no fluid can be transferred between the first and second fluid chambers 56A, 56B.

In an example embodiment, the first and second fluid chambers 56A, 56B and one or both of the first metered fluid passage 60A and the second metered fluid passage 60B define a closed fluid system. The term “closed fluid system” is meant so signify that, during operation of the handwheel actuator 100: i) fluid is not supplied to the closed fluid system from a source outside of the handwheel actuator 100 (such as, but not limited to, a pump), and ii) fluid is not exited from the closed fluid system to a reservoir or component outside of the handwheel actuator 100. Stated otherwise, the closed fluid system is self-contained such that all of its fluid, and the exchange thereof, remains within the handwheel actuator 100.

In an example embodiment, the handwheel 10 rotational resistance can be adjusted with software of the ECU 95; stated otherwise, the rotational resistance provided by the second metered fluid passage 60B is selectively variable. The electronic control valve 40 can be commanded to have more or less flow restriction, which, in turn, effects the torque required to turn the handwheel 10. In a further aspect, the software can vary the rotational resistance based on handwheel 10 speed and/or vehicle speed.

In an example embodiment, the rotational resistance of the handwheel 10 increases with increased rotational speed of the handwheel 10.

In an example embodiment, the rotational resistance of the handwheel 10 increases with vehicle speed.

The handwheel actuator 100 includes a handwheel sensor 70 that electronically communicates a rotational position and a rotational speed of the handwheel 10 to the ECU 95 via sensing of the second end 20 of the shaft 18. The handwheel sensor 70 is attached to the second end cap 11B of the housing 55 via fasteners 71 and cooperates with the second end 20 of the shaft 18 to provide the rotational position and the rotational speed of the shaft 18.

The handwheel actuator 100 provides a rotational resistance or a resistant torque to the handwheel 10 via axial forces that act on the piston 30. In an example embodiment, when the handwheel 10 moves in the first rotational direction R1, the piston 30 moves in the first axial direction X1 via the threaded interface 93. Turning to FIGS. 1, 2, and 5, when an input torque T1 is applied to the handwheel 10 to rotate it in the first rotational direction R1, a first resistant torque TRes1 is applied to the shaft 18 via a first axial force FP1 that acts on the first axial surface 31 of the piston 30. The first axial force FP1 is derived from a fluid pressure P1 within the first fluid chamber 56A that results from compression of the first fluid chamber 56A. The first axial force FP1 is a product of multiplying the fluid pressure P1 by a pressurized area A1 (area which is acted on by pressure P1) of the first axial surface 31 of the piston 30. The first axial force FP1, or the fluid pressure factor thereof, can be varied via electronic control of a rate of fluid exchange between the first fluid chamber 56A and the second chamber 56B. This rate of fluid exchange is governed by the second metered fluid passage 60B, particularly by the electronic control valve 40 which manages a fluid restriction within the second metered fluid passage 60B, subsequently controlling the flow of fluid through the second metered fluid passage 60B.

In a further example embodiment, when the handwheel 10 moves in the second rotational direction R2, the piston moves in the second axial direction X2 via the threaded interface. Turning again to FIGS. 1, 2, and 5, when an input torque T2 is applied to the handwheel 10 to rotate it in the second rotational direction R2, a second resistant torque TRes2 is applied to the shaft 18 via a second axial force FP2 that acts on the second axial surface 33 of the piston 30. The second axial force FP2 is derived from a fluid pressure P2 within the second fluid chamber 56B that results from compression of the second fluid chamber 56B. The second axial force FP2 is a product of multiplying the fluid pressure P2 by a pressurized area A2 (area which is acted on by pressure P2) of the second axial surface 33 of the piston 30. The second axial force FP2, or the fluid pressure factor thereof, can be varied via electronic control of a rate of fluid exchange between the second fluid chamber 56B and the first fluid chamber 56A. This rate of fluid exchange is governed by the second metered fluid passage 60B, particularly by the electronic control valve 40 which manages a fluid flow restriction within the second metered fluid passage 60B via selective obstruction of the second metered fluid passage 60B.

The handwheel actuator 100 includes a first spring 80 arranged within the first fluid chamber 56A and a second spring 81 arranged within the second fluid chamber 56B. One end of the first spring 80 abuts with a step 54 that protrudes radially inwardly from the radial inner surface of a bore 53 of the enclosure 50. An opposite end of the first spring 80 abuts with the first axial surface 31 of the piston 30. One end of the second spring 81 abuts with the second end cap 11B, and an opposite end of the second spring abuts with the second axial surface 33 of the piston 30. The first and second springs 80 can be replaced by any suitable force generators within the respective first and second fluid chambers 56A, 56B. The first and second springs 80 are configured to return the handwheel 10 to a home position, which can be defined by either: i) a straight or non-turning position of the handwheel 10 and wheels 86, or ii) a position in which the net spring force acting on the piston 30 is zero. Thus, the first and second springs 80, 81 provide axial forces that overcome an inherent friction of the threaded interface 93 to move the piston 30 axially so that the shaft 18 is rotated to return the handwheel 10 to its home position. Thus the shaft 18 receives a return torque via the axial forces provided by the first and second springs 80, 81. In such an instance, an input axial or linear displacement of the piston 30 via the first and second springs 80, 81 is converted to an output rotary motion of the shaft 18 and handwheel 10; thus, the threaded interface 93 is backdrivable via the first and second springs 80, 81. The term “backdrivable” means that a force to an output, such as the piston 30 in this instance, is configured to actuate an input, such as the handwheel 10 in this instance. FIG. 5 shows a first axial spring force FS1 that acts on the first axial surface 31 of the piston 30 in the second axial direction X2, and a second axial spring force FS2 that acts on the second axial surface 33 of the piston 30 in the first axial direction X1. In the home position of the handwheel 10, the first axial spring force FS1 acting on the piston 30 is equal and opposite to the second axial spring force FS2 acting on the piston 30.

In a turning position of the handwheel 10, the piston 30, in an example embodiment, is moved via the threaded interface 93 away from its linear home position and towards the second end 58 of the housing 55. In this “first skewed” linear position of the piston 30, the second spring 81 is compressed more than the first spring 80 and yields a greater axial force than the first spring 81. Thus, when an input torque is removed from the handwheel 10 at such a first skewed linear position of the piston 30, the piston 30 is returned to its linear home position via the second axial spring force FS2, which also imparts a return torque TR2 to the shaft 18 and handwheel 10 via the threaded interface 93. Likewise, when the piston 30 is skewed toward the first end 57 of the housing 55 (a second skewed linear position), when an input torque is removed from the handwheel 10, the piston is returned to its linear home position via the first axial spring force FS1, which also imparts a return torque TR1 to the shaft 18 and handwheel 10 via the threaded interface 93.

The previously described piston 30 and its associated axial faces could also be described as a wall 75 that is movable in an axial direction. Correspondingly, the first volume V1 and the second volume V2 are expandable and compressible via the wall 75; and the first volume V1 is sealingly separated from the second volume V2 via the wall 75. Furthermore, the wall 75 is capable of receiving the previously described first and second spring forces FS1, FS2 and the first and second axial forces FP1, FP2.

Turning to FIGS. 8 and 9, an example embodiment of a handwheel actuator 200 is shown that adheres to the same operating principles as described for the handwheel actuator 100 of FIGS. 1-5, therefore further discussion about the function and operation is not needed. The handwheel actuator 200 includes a piston 130 that is void of an orifice or a metered fluid passage that extends through the piston 130. Thus, the piston 130 slidably and sealingly separates a first fluid chamber 156A from a second fluid chamber 156B via a piston circumferential seal 190. A metered fluid passage 160 is arranged between the first and second fluid chambers 156A, 156B that includes the electronic valve 40 of FIG. 6 or any other suitable electronic or non-electronic valve. A first spring 180 and a second spring 181 have a larger cross-sectional area than the previously described first and second springs 80, 81, to accommodate greater spring forces. Additionally, each of the first and second springs 180, 181 includes a two-piece nested spring retainer 182 configured to apply a pre-load to the first and second springs 180, 181 and/or optimize a force output of the first and second springs 180, 181. A piston-side retainer 183 moves axially within or telescopes within a housing-side retainer 185 as the piston 130 is moved axially. Other suitable retainers or springs than what is shown and described can also be utilized. A housing 155 of the handwheel actuator 200 includes a cup-shaped enclosure 150 and an end cap 111. A shaft 118 is supported by two double-row ball bearings 117 such as, but not limited to, angular contact ball bearings.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A handwheel actuator for a steering system, comprising:
a housing;
a piston slidably disposed within a bore of the housing, the piston having:
a first end forming a first fluid chamber with the bore of the housing; and
a second end forming a second fluid chamber with the bore of the housing, the second fluid chamber configured to be fluidly connected to the first fluid chamber; and
a shaft disposed within the housing and configured to be rotatably driven by a handwheel; and
the shaft and piston cooperate to convert an input rotary motion of the shaft to an output linear motion of the piston, and the output linear motion of the piston is configured to displace a fluid so as to apply a selectively variable rotational resistance to the shaft.

2. The handwheel actuator of claim 1, wherein the shaft and the piston define a threaded interface configured to convert the input rotary motion of the shaft to the output linear motion of the piston.

3. The handwheel actuator of claim 1, wherein rotation of the shaft in a first rotational direction causes the piston to move in a first axial direction, and rotation of the shaft in a second rotational direction causes the piston to move in a second axial direction.

4. The handwheel actuator of claim 3, wherein movement of the piston in the first axial direction reduces a volume of the first fluid chamber and increases a volume of the second fluid chamber, and movement of the piston in the second axial direction increases the volume of the first fluid chamber and decreases the volume of the second fluid chamber.

5. The handwheel actuator of claim 1, wherein linear motion of the piston is configured to push the fluid out of one of the first fluid chamber or the second fluid chamber and into a remaining one of the first fluid chamber or the second fluid chamber so as to produce the selectively variable rotational resistance.

6. The handwheel actuator of claim 1, wherein the piston comprises a metered fluid passage configured to fluidly connect the first fluid chamber to the second fluid chamber, the metered fluid passage having an electronic control valve configured to control the selectively variable rotational resistance.

7. The handwheel actuator of claim 1, further comprising a metered fluid passage configured to fluidly connect the first fluid chamber to the second fluid chamber, and the metered fluid passage is electronically metered.

8. The handwheel actuator of claim 1, further comprising a fluid flow path fluidly connecting the first fluid chamber to the second fluid chamber, and the selectively variable rotational resistance is provided via selectively varying a flow area of the fluid flow path.

9. The handwheel actuator of claim 1, further comprising a first spring arranged within the first fluid chamber and a second spring arranged within the second fluid chamber.

10. The handwheel actuator of claim 9, wherein the first spring is configured to apply a first axial force to a first axial end of the piston, and the second spring is configured to apply a second axial force to a second axial end of the piston.

11. The handwheel actuator of claim 9, wherein the first spring and the second spring are configured to move the piston to a linear position configured to correspond with a non-turning position of the handwheel.

12. The handwheel actuator of claim 1, wherein the shaft extends through the piston and is rotatably supported by the housing.

13. The handwheel actuator of claim 1, wherein the shaft and piston cooperate to convert an input linear motion of the piston to an output rotary motion of the shaft.

14. A handwheel actuator for a steering system, comprising:
a housing having;
a rotational axis;
a wall movable in an axial direction;
a first volume expandable and compressible via the wall;
a second volume expandable and compressible via the wall, the second volume sealingly separated from the first volume via the wall; and
a shaft configured to receive: i) an input torque via a handwheel, ii) a resistant torque via the first volume and the second volume, and iii) a return torque via the first volume and the second volume, the return torque configured to rotate the shaft so as to rotate the handwheel to a non-turning position.

15. The handwheel actuator of claim 14, wherein the resistant torque is provided via compressed fluid within one of the first volume or the second volume.

16. The handwheel actuator of claim 14, wherein the return torque is provided via a first axial force applied within the first volume or a second axial force applied within the second volume.

17. The handwheel actuator of claim 14, wherein the shaft extends through the first volume and the second volume.

18. The handwheel actuator of claim 17, wherein the shaft extends outside of the housing.

19. The handwheel actuator of claim 14, wherein the wall and the shaft define a threaded interface configured to convert rotary movement of the shaft to linear movement of the wall.

20. The handwheel actuator of claim 14, wherein:
when the shaft rotates in a first direction, the first volume decreases in size and the second volume increases in size; and
when the shaft rotates in a second direction, the first volume increases in size and the second volume decreases in size.
